(19) United States
(12) Patent Application Publication
(10) Pub. No.: US 2023/0249994 A1
(43) Pub. Date: Aug. 10, 2023

(54) CONTROLLABLE ADVANCED DECOMPOSITION EQUIPMENT FOR INDUSTRIAL PROCESS-WATER CONTAINING NON-BIODEGRADABLE ORGANICS AND IN-ORGANICS

(71) Applicant: Yoonjin Environment Co., Ltd, Busan (KR)

(72) Inventors: Jung-A Rhim, Busan (KR); Jeong-hyo Yoon, Busan (KR); Mal-suk Ko, Busan (KR); Tae-young Ru, Busan (KR); Gun-pio Lee, Busan (KR); Hyoung-ho Kim, Busan (KR)

(73) Assignee: Yoonjin Environment Co., Ltd, Busan (KR)

(21) Appl. No.: 17/667,177

(22) Filed: Feb. 8, 2022

(51) Int. Cl. C02F 1/461

(52) U.S. Cl. CPC C02F 1/46109; C02F 2001/46133; C02F 2101/30

(57) ABSTRACT

A controllable advanced decomposition equipment for industrial process-water containing non-biodegradable organics and in-organics, which is configured in multiple stages, includes: an ozone dissolving tank, a hydroxyl radical forming tank, and a gas-liquid separation tank as a unit process are configured in multiple stages. A G/L ratio is controlled by adjusting an ozone-gas amount and a circulating-water amount, thus maximizing ozone availability in the ozone dissolving tank, and then a current density is adjusted in the hydroxyl-radical forming tank to maximize the generated amount of hydroxyl radicals due to the charging of semiconductor catalyst, thus controlling the treatment efficiency of non-biodegradable process water.

### BACKGROUND

An advanced oxidation process (AOP) generates hydroxyl radicals (OH) in water to oxidize and decompose organics, and is the most advanced technology in chemical treatment methods. Examples of the advanced oxidation process include Fenton oxidation, a semiconductor photocatalytic process (TiO₂/UV), an ozone combination process (O₃/H₂O₂, O₃/UV), etc. The ozone and ultraviolet (254 nm) combination process is advantageous in that ozone absorbs ultraviolet rays and undergoes photodecomposition to generate hydroxyl radicals through a decomposition mechanism, so that sludge generation and chemical costs can be greatly reduced, but is problematic in that treatment efficiency is lowered due to a reduction in UV intensity when wastewater is highly turbid.

In order to solve the problem, the previous invention (KR Patent No. 10-0542270) of the present inventors has proposed a hydroxyl radical generator by ozone, semiconductor catalyst, and electrolysis. The generator oxidizes and decomposes contaminants in water to reduce the generated amount of sludge, reduce chemical costs, and solve the problem of a UV light source, so that this can be effectively applied to wastewater. The cited invention converts ozone generated in an ozone generator into hydroxyl radicals by a semiconductor catalyst and an electrode to decompose non-biodegradable material in fluid. In this invention, ozone gas generated in the ozone generator is dissolved in a hydroxyl radical forming tank and hydroxyl radicals are generated from the dissolved ozone, so that the configuration and design of a reaction tank considering a mass transfer rate for generating a high concentration of dissolved ozone are required. The overall mass transfer rate of the dissolved ozone is as follows.

$$\begin{matrix}\frac{dC}{dt} = {k}_{Lo} ( {C}_{s} - C ) & ( 1 ) \\ {k}_{Lo} = {k}_{L} \times a & ( 2 ) \\ a = \frac{A}{V} = \frac{6}{d} & ( 3 ) \\ {k}_{L} = \frac{{DN}_{sk}}{L} & ( 4 )\end{matrix}$$

where

$$\frac{dC}{dt} :$$

overall mass transfer rate
k_{La}: overall mass transfer coefficient
Cₛ− [symbol] : difference between saturated dissolved concentration and current dissolved concentration
a: specific boundary area of bubble (cm²/cm³)
d: diameter of bubble (cm)
k_{L}: liquid mass transfer coefficient (cm/sec)
Nₛₕ: : Sherwood number (-)
D: molecule diffusion coefficient (cm²/sec)
L: reaction-tank height (cm)

A microbubble generator and a microbubble generating apparatus having the same (10-2002-7016888) pressurize introduced water to vertically collide with ozone gas and thereby make microbubbles, thus increasing the specific boundary area of bubbles and thereby increasing the overall mass transfer coefficient. However, since the pressure of the introduced bubbles is high, the bubbles are not dissolved in water but rapidly rise to a water surface, resulting in a low dissolution rate in water.

According to the existing invention (KR Patent No. 10-1370105), ozone generated in an ozone generator is generated as dissolved ozone in a separate dissolved-ozone dissolving tank to increase an ozone dissolution rate, and subsequently a rate-determining step which is a first stage of an ozone decomposition mechanism is controlled by an electrode formed in a hydroxyl-radical forming tank and a charged semiconductor catalyst to rapidly generate hydroxyl radicals. However, when manufacturing a large-capacity reactor with a large treatment amount, an expensive turbo motor should be used in a dissolved-ozone contact tank, and a dead-space may occur in the dissolved-ozone contact tank, so that the availability of ozone may be lowered. Therefore, the present disclosure uses a general high-speed motor instead of using the expensive turbo motor in the ozone dissolving tank to enhance economic efficiency, and forms a multi-stage process to maintain an appropriate G/L ratio, thus structurally maximizing the ozone availability to promote the generation of hydroxyl radicals and efficiently control non-biodegradable process water.

### SUMMARY

The objectives of controllable advanced decomposition equipment for industrial process-water containing non-biodegradable organics and in-organics according to the present disclosure are as follows.

First, an ozone dissolving tank of the present disclosure performs a rapid stirring operation at high speed when bubbles diffused in a diffusion stone 1-6 are dissolved with a motor/motor head 1-4 located at the upper end of the outer circumference and a flat-plate impeller 1-5 connected therewith and formed on the lower portion of the center of the inside, thus increasing a mass transfer rate to process raw water and allowing the upper and lower portions of the ozone gas to be smoothly mixed by an ozone dissolving tank double inner-wall fluid circulator formed on the lower portion of the inner wall of the ozone dissolving tank while maintaining a residence time, and thereby increasing the mass transfer rate of the ozone gas into the process raw water and greatly increasing an ozone dissolution rate due to horizontal agitation and an increase in vertical mixing flow.

According to the preceding invention [10-1370105] of the present inventors, an impeller is located under a water surface of a dissolved-ozone contact tank to dissolve ozone gas which is microbubbles floating on a surface. On the other hand, the flat-plate impeller of the ozone dissolving tank according to the present disclosure is located at the lower portion of the ozone dissolving tank to rapidly mix the ozone gas discharged from a diffusion stone at high speed, and introduces fluids discharged from the ozone dissolving tank double inner-wall fluid circulator provided on the lower portion of the ozone dissolving tank into an inner partition wall as an upward flow, thus allowing the upper and lower portions of the ozone gas to be smoothly mixed while maintaining the residence time, and thereby increasing the mass transfer rate of the ozone gas into the process raw water and greatly increasing the ozone dissolution rate due to the horizontal agitation and the increase in vertical mixing flow.

Second, a hydroxyl-radical forming tank of the present disclosure forms a hydroxyl-radical forming tank process treatment water outflow weir overflow part 2-6 to prevent channeling, thus promoting an advanced decomposition reaction by hydroxyl radicals due to uniform contact of charged semiconductor catalyst with ozone dissolution circulating water/process raw water.

According to the preceding invention [10-1370105] of the present inventors, a fluid outlet of a hydroxyl-radical forming tank is formed of one outlet, thus slightly generating channeling when fluid introduced from a lower portion flows upwards. On the other hand, the hydroxyl-radical forming tank of the present disclosure forms the hydroxyl-radical forming tank process treatment water outflow weir overflow part 2-6 to prevent channeling, thus promoting the advanced decomposition reaction by the hydroxyl radicals due to the uniform contact of the charged semiconductor catalyst with the ozone dissolution circulating water/process raw water.

Third, a gas-liquid separation tank of the present disclosure forms a gas-liquid separation tank exhaust gas discharge port 3-6 to discharge exhaust gas such as CO² or N₂ after non-biodegradable process water is decomposed, thus increasing an ozone dissolution rate when the gas-liquid separation tank circulating water is circulated and introduced into the ozone dissolving tank 1-1. According to the preceding invention [10-1370105] of the present inventors, first raw water is introduced into a fluid circulation tank, and the emission of harmful ozone exhaust gas is prevented to be used to dispose of a trace of remaining material by dispersing, a trace of ozone exhaust gas remaining after it reacts in a hydroxyl radical forming tank, to a diffusion stone. On the other hand, the gas-liquid separation tank of the present disclosure forms the gas-liquid separation tank exhaust gas discharge port 3-6 to discharge the exhaust gas such as CO₂ or N₂ after the non-biodegradable process water is decomposed, thus increasing the ozone dissolution rate when the gas-liquid separation tank circulating water is circulated and introduced into the ozone dissolving tank 1-1.

Fourth, controllable advanced decomposition equipment for industrial process-water containing non-biodegradable organics and in-organics of the present disclosure is configured in multiple stages, so that a general high-speed motor is used instead of using an expensive turbo motor in an ozone dissolving tank, thus enhancing economic efficiency, and a dead-space of the ozone dissolving tank is reduced, thus enabling smooth mixing and structurally maximizing ozone availability.

### BRIEF DESCRIPTION OF THE DRAWINGS

FIG. 1 is a top view illustrating controllable advanced decomposition equipment for industrial process-water containing non-biodegradable organics and in-organics.

FIG. 2 is a top view illustrating a multi-stage part of the controllable advanced decomposition equipment for the industrial process-water containing the non-biodegradable organics and in-organics.

FIG. 3 is a side view illustrating the controllable advanced decomposition equipment for the industrial process-water containing the non-biodegradable organics and in-organics.

FIG. 4 is a top view illustrating a one-stage part of the controllable advanced decomposition equipment for the industrial process-water containing the non-biodegradable organics and in-organics.

FIG. 5 is a sectional view illustrating an ozone dissolving tank of the controllable advanced decomposition equipment for the industrial process-water containing the non-biodegradable organics and in-organics.

FIG. 6 is a top view illustrating a hydroxyl-radical forming tank of the controllable advanced decomposition equipment for the industrial process-water containing the non-biodegradable organics and in-organics.

FIG. 7 is a sectional view illustrating the hydroxyl-radical forming tank of the controllable advanced decomposition equipment for the industrial process-water containing the non-biodegradable organics and in-organics.

FIG. 8 is a sectional view illustrating a gas-liquid separation tank of the controllable advanced decomposition equipment for the industrial process-water containing the non-biodegradable organics and in-organics.

FIG. 9 is a sectional view illustrating an ejector of the ozone dissolving tank of the controllable advanced decomposition equipment for the industrial process-water containing the non-biodegradable organics and in-organics.

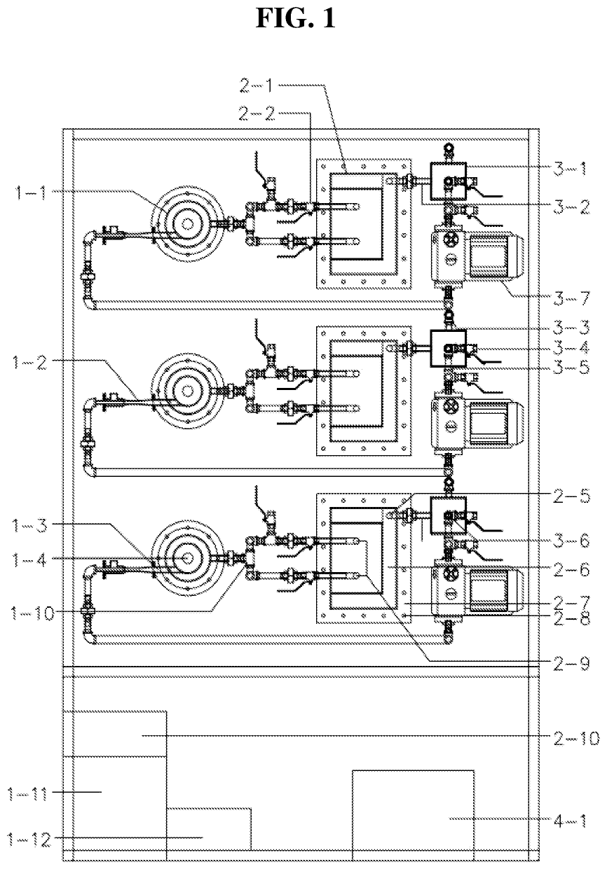

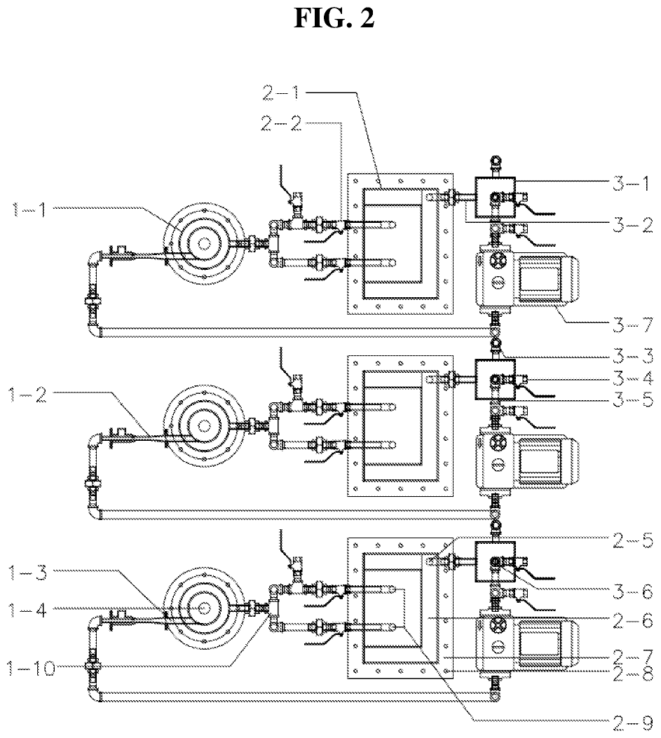

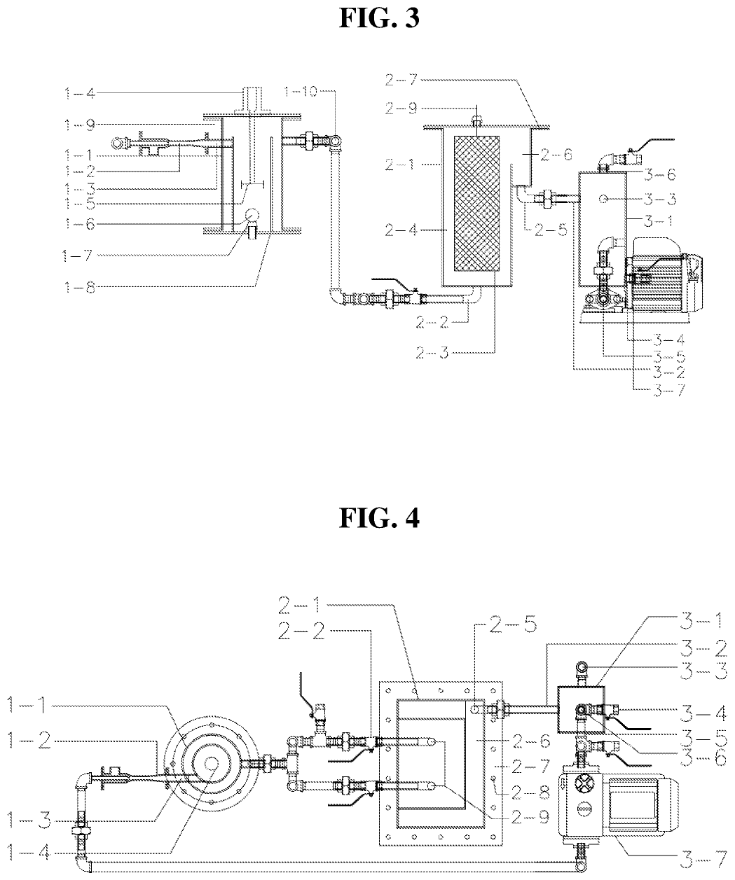

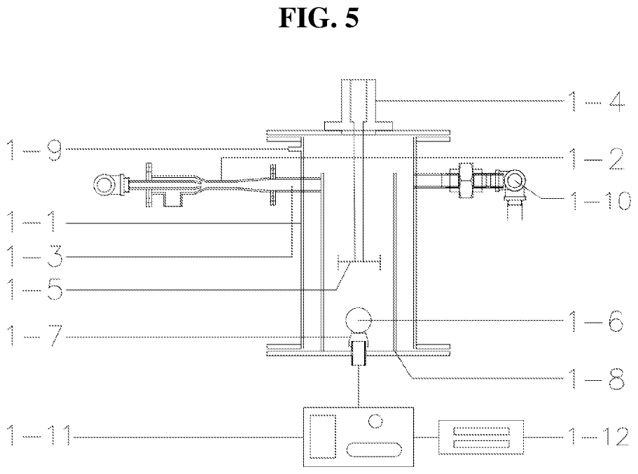

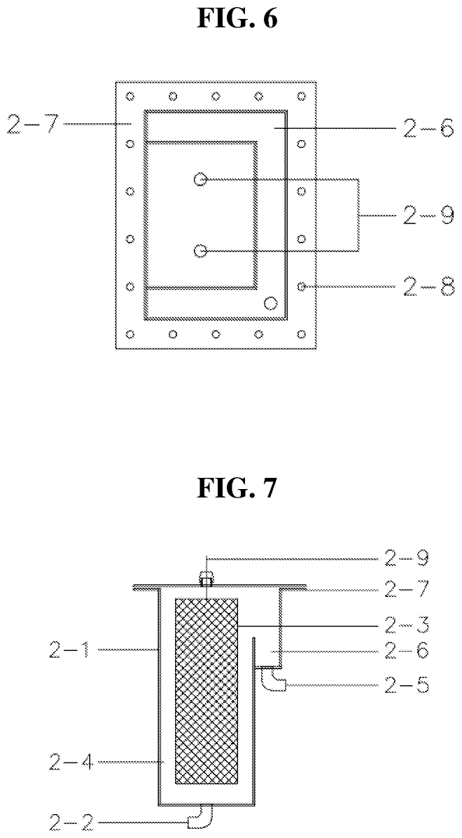

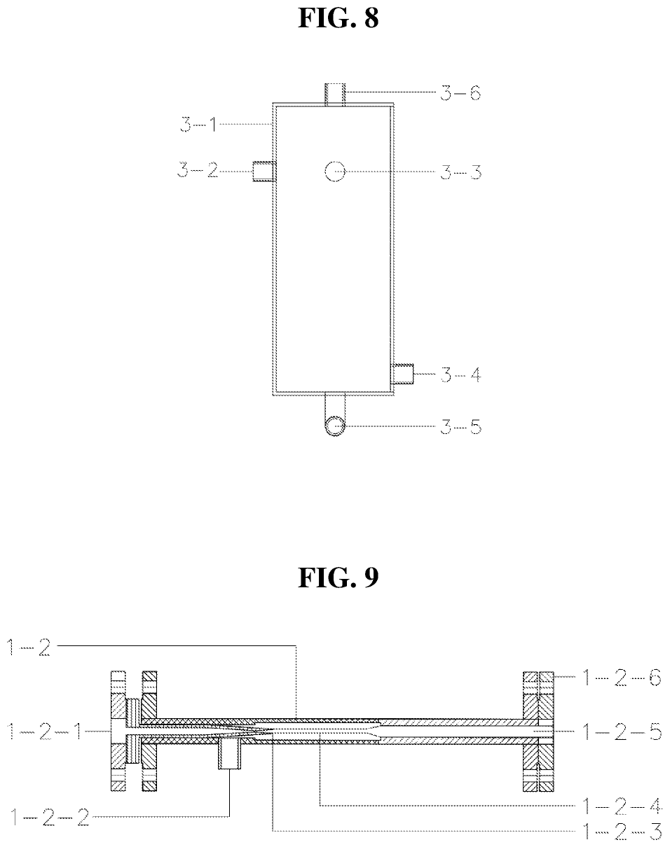

### DETAILED DESCRIPTION

The multi-stage process flow and treatment mechanism of controllable advanced decomposition equipment for industrial process-water containing non-biodegradable organics and in-organics according to the present disclosure are as follows. When process water treated through an ozone dissolving tank, a hydroxyl-radical forming tank, and a gas-liquid separation tank in a first stage is transferred to an ozone dissolving tank in a second stage, the process water is sucked through a process-raw-water inlet of the ozone dissolving tank of an ejector formed on a front end of the ozone dissolving tank to suck water through negative pressure, maximizes the availability of ozone in the ozone dissolving tank, maximizes the generated amount of the hydroxyl radical in the hydroxyl-radical forming tank to decompose non-biodegradable process water, discharges exhaust gas from a gas-liquid separation tank, highly decomposes process treatment water in the ozone dissolving tank and the hydroxyl-radical forming tank in a third stage, discharges the exhaust gas from the gas-liquid separation tank, and thereafter discharges final process treatment water.

The configuration and operation of the controllable advanced decomposition equipment for the industrial process-water containing the non-biodegradable organics and in-organics according to the present disclosure will be described in detail with reference to reference numerals.

The controllable advanced decomposition equipment includes an ozone dissolving tank 1-1 which rapidly dissolves ozone gas introduced into an ozone generator 1-11 through a unit process located at a front end of the controllable advanced decomposition equipment for the industrial process-water containing the non-biodegradable organics and in-organics by increasing a mass transfer rate into process raw water, and includes a motor/motor head 1-4, a flat-plate impeller 1-5, a diffusion stone 1-6, and a double inner-wall fluid circulator 1-8 of the ozone dissolving tank, thus maximizing the availability of ozone.

An ejector 1-2 is located to be connected to a front end of the ozone dissolving tank 1-1, generates negative pressure, and allows process raw water and circulating water to be sucked into the ozone dissolving tank while maintaining a flow rate.

An ozone-dissolving-tank circulating water inlet 1-2-1 is located at a front end of the ejector such that gas-liquid separation tank circulating water adjusted to a proper G/L ratio is introduced therein.

An ozone dissolving tank process-raw-water inlet 1-2-2 is located under the front end of the ejector, so that process raw water of the ozone dissolving tank is introduced into the inlet in a first stage process, and gas-liquid separation tank process treatment water is introduced into the inlet in a second stage process and a third stage process.

An ejector nozzle 1-2-3 is located in the ejector 1-2 and has a fine hole, so that ozone-dissolving-tank circulating water and ozone-dissolving-tank process raw water are sprayed and introduced in the first stage process, and ozone-dissolving-tank circulating water and ozone-dissolving-tank process raw water are sprayed and introduced in the second stage process and the third stage process.

An ejector mixing pipe 1-2-4 is located in the ejector 1-2 and at the rear end of the ejector nozzle, thus effectively mixing the introduced circulating water and process raw water.

An ejector diffuser 1-2-5 is located at the rear end of the ejector mixing pipe 1-2-4, so that the circulating water and the process raw water mixed in the ejector mixing pipe 1-2-4 are diffused and introduced.

An ejector flange 1-2-6 is located to be connected to the outer circumference of the ejector diffuser 1-2-5, and is joined to prevent the ozone-dissolving-tank circulating water/the process raw water in the ejector from leaking out.

An ozone-dissolving-tank circulating water/process-raw-water inlet 1-3 is located to be connected to the rear end of the ejector diffuser 1-2-5, so that the gas-liquid separation tank circulating water and the process raw water are mixed, diffused, and introduced, according to a liquid flow rate (L: Liquid-flow rate=circulating-water amount+process-raw-water amount) calculated in an appropriate G/L ratio.

A motor/motor head 1-4 is located at the central portion of the upper end of the outside of the ozone dissolving tank 1-1, and adjusts the rotating speed of a flat-plate impeller to allow a mixing intensity to be adjusted.

A flat-plate impeller 1-5 is located to be connected to the motor/motor head 1-4, and is formed in a flat plate to effectively mix ozone gas.

A diffusion stone 1-6 is located at the center of the lower portion of the inside of the ozone dissolving tank 1-1 to disperse the ozone gas introduced from the ozone generator.

An ozone gas inlet 1-7 is located at the center of the inside of the dual structure of the ozone dissolving tank, so that the ozone gas generated at the ozone gas flow rate G of the appropriate G/L ratio in the ozone generator is introduced.

A double inner-wall fluid circulator 1-8 of the ozone dissolving tank is located at the lower portion of the inner wall of the ozone dissolving tank 1-1 to smoothly mix upper and lower portions of the ozone gas and maintain residence time, thus greatly increasing an ozone dissolution rate due to an increase in vertical mixing flow.

A gas circulation outlet 1-9 of the ozone dissolving tank is located on a side of the outer circumference of the upper portion of the ozone dissolving tank 1-1, so that ozone gas of exhaust gas which is discharged without being dissolved among the continuously introduced ozone gas is introduced to a hydroxyl-radical forming tank circulating water/ozone dissolution process-raw-water inlet 2-2 to be circulated and reused.

An ozone dissolution circulating water/process raw water outlet 1-10 of the ozone dissolving tank is located to be connected to the lower end of the gas circulation outlet 1-9 of the ozone dissolving tank via a T-shaped pipe, so that circulating water/process raw water in which a large amount of ozone gas is dissolved is discharged.

An ozone generator 1-11 is located on a side of the outside of the ozone dissolving tank 1-1 to generate ozone gas and then supply the ozone gas through the ozone gas inlet 1-7 of the ozone dissolving tank to the ozone dissolving tank.

An oxygen generator 1-12 is located on a side of the outside of the ozone generator 1-11 to generate oxygen gas and then supply the oxygen gas to the ozone generator 1-11.

A hydroxyl-radical forming tank 2-1 is located to be connected to the rear end of the ozone dissolving tank 1-1, directly ionizes dissolved ozone into O₃⁻ (ozonide) by an electrode charged with DC power supply and a semiconductor catalyst, generates HO₃ radicals by reacting ionized O₃⁻ and H⁺, and then rapidly generates oxygen and hydroxyl radicals from the HO₃ radicals.

A hydroxyl-radical forming tank circulating water/ozone dissolution process-raw-water inlet 2-2 is located at the center of the lower portion of the hydroxyl-radical forming tank 2-1, so that the circulating water/process raw water which is discharged from the ozone-dissolving-tank ozone dissolution circulating water/process raw water outlet 1-10 and in which a large amount of ozone is dissolved and the ozone gas discharged from the gas circulation outlet 1-9 of the ozone dissolving tank are introduced together.

Positive and negative electrodes 2-3 are formed at regular intervals between charging parts of the semiconductor catalyst 2-4 inside the hydroxyl-radical forming tank 2-1, and are located to be connected to positive and negative electrode electrical connectors 2-9 of the external hydroxyl-radical forming tank, thus transferring electrons to the semiconductor catalyst by the supply of electricity from the DC power supply 2-10.

The semiconductor catalyst 2-4 is located to be charged in the hydroxyl-radical forming tank 1-1, and receives electrons generated from the electrode supplied with electricity from the DC power supply to promote the formation of the ozonide (O₃⁻) from ozone.

A hydroxyl-radical forming tank process treatment water outlet 2-5 is located on a side of the outer circumference of the upper portion of the hydroxyl-radical forming tank 2-1, so that the non-biodegradable process water is highly decomposed by reacting with the hydroxyl radicals which are rapidly generated by the charged semiconductor catalyst and then is discharged.

A hydroxyl-radical forming tank process treatment water outflow weir overflow part 2-6 is located at the upper end of the inside of the hydroxyl-radical forming tank 2-1, and prevents channeling to allow the charged semiconductor catalyst and the ozone dissolution circulating water/process raw water to uniformly contact each other.

A hydroxyl-radical forming tank upper flange 2-7 is located at the upper portion of the hydroxyl-radical forming tank 2-1 to prevent the fluid of the hydroxyl-radical forming tank from leaking out.

An upper-flange bolt hole 2-8 of the hydroxyl-radical forming tank is located at the hydroxyl-radical forming tank upper flange 2-7, and has a hole which is used to fasten the flange so as to prevent the fluid of the hydroxyl-radical forming tank from leaking out.

An electrical connector 2-9 of the hydroxyl-radical forming tank positive and negative electrodes is located at the upper end of the outside of the hydroxyl-radical forming tank 2-1, and has a connector to which an electric wire is connected to supply electricity to the positive and negative electrodes.

A DC power supply 2-10 is located at the outside of the hydroxyl-radical forming tank 2-1 to supply electricity to the positive and negative electrodes.

A gas-liquid separation tank 3-1 is located at the rear end of the hydroxyl-radical forming tank 2-1, and has a gas-liquid separation tank circulating water outlet 3-5 circulated to the ozone-dissolving-tank circulating water inlet 1-2-1, thus controlling the availability of the ozone gas by adjusting a G/L ratio, which is the ratio of the ozone-gas flow rate G to the process-water flow rate L, to the process-water flow rate (the sum of the process-raw-water flow rate and the circulating-water flow rate).

A gas-liquid separation tank hydroxyl-radical forming tank process treatment water inlet 3-2 is located on a side of the upper end of the outer circumference of the gas-liquid separation tank 3-1, so that hydroxyl-radical forming tank process treatment water discharged from a treatment water outlet 2-5 of the hydroxyl-radical forming tank is introduced.

A gas-liquid separation tank process treatment water outlet 3-3 is located to be perpendicular to the gas-liquid separation tank hydroxyl-radical forming tank process treatment water inlet 3-2 in a counterclockwise direction, so that it is an outlet through which final process treatment water is discharged in the first stage process, as treatment water from which exhaust gas is discharged, and it is an outlet through which the discharged final process treatment water is sucked and transferred to the ozone-dissolving-tank process-raw-water inlet 1-2-2 in the second stage process.

A gas-liquid separation tank circulating water inlet 3-4 is located to form 180 degrees with the gas-liquid separation tank hydroxyl-radical forming tank process treatment water inlet 3-2 in the counterclockwise direction, and is connected to a pump outlet, located on a side of the lower end of the gas-liquid separation tank 3-1, via the T-shaped pipe, so that some circulating water is transferred to the ozone-dissolving-tank circulating water inlet 1-2-1 and some circulating water is introduced into the gas-liquid separation tank circulating water inlet.

A gas-liquid separation tank circulating water outlet 3-5 is located to be perpendicular to the gas-liquid separation tank circulating water inlet 3-4 in a clockwise direction. Some circulating water is introduced into and discharged out from the pump to be transferred to the gas-liquid separation tank circulating water inlet 1-2-1, and some circulating water is circulated and introduced into the gas-liquid separation tank circulating water inlet 3-4. Here, the gas-liquid separation tank circulating water outlet is the outlet through which circulating water is discharged to the pump inlet.

A gas-liquid separation tank exhaust gas discharge port 3-6 is located at the center of the upper end of the gas-liquid separation tank 3-1, and discharges exhaust gas such as CO₂ or N₂ after the non-biodegradable process water is decomposed, thus increasing an ozone dissolution rate when the gas-liquid separation tank circulating water is circulated and introduced into the ozone dissolving tank 1-1.

A pump 3-7 is located to be connected to a side of the gas-liquid separation tank circulating water outlet 3-5 via the pump inlet and the pipe, causes the circulating water discharged from the pump outlet to be transferred to the gas-liquid separation tank circulating water inlet 1-2-1, and causes some circulating water to be circulated and introduced into the gas-liquid separation tank circulating water inlet 3-4.

A control panel 4-1 is located under the DC power supply 2-10, and is an electric control panel for the motor/motor head 1-4, the DC power supply, and the pump. The controllable advanced decomposition equipment for the industrial process-water containing the non-biodegradable organics and in-organics configured as described above can efficiently and highly decompose the non-biodegradable process water.

The configuration and operation of the controllable advanced decomposition equipment for the industrial process-water containing the non-biodegradable organics and in-organics according to the present disclosure will be described as follows with reference to main unit processes.

In order to dissolve the ozone gas, which is generated in the ozone generator 1-11 and is introduced into the center of the lower portion, in the process raw water which is introduced through the ozone dissolving tank process-raw-water inlet 1-2-2 formed on the ejector 1-2, the ozone dissolving tank 1-1 rapidly stirs the ozone gas at high speed when bubbles diffused in the diffusion stone 1-6 are dissolved with the motor/motor head 1-4 located at the upper end of the outer circumference and the flat-plate impeller 1-5 connected therewith and formed on the lower portion of the center of the inside, thus increasing the mass transfer rate to the process raw water and allowing the upper and lower portions of the ozone gas to be smoothly mixed by the ozone dissolving tank double inner-wall fluid circulator 1-8 formed on the lower portion of the inner wall of the ozone dissolving tank while maintaining the residence time, and thereby increasing the mass transfer rate of the ozone gas into the process raw water and greatly increasing the ozone dissolution rate due to horizontal agitation and an increase in vertical mixing flow.

The hydroxyl-radical forming tank 2-1 is located to be connected to the ozone dissolving tank ozone dissolution circulating water/process raw water outlet 1-10, the positive and negative electrodes 2-3 and the semiconductor catalyst 2-4 are formed to control the rate-determining step of the ozone decomposition reaction and thereby generate a large amount of hydroxyl radicals, and the hydroxyl-radical forming tank process treatment water outflow weir overflow part 2-6 is formed to prevent channeling, thus promoting the advanced decomposition reaction by the hydroxyl radicals due to uniform contact of the charged semiconductor catalyst with the ozone dissolution circulating water/process raw water.

The control panel 4-1 is located at the rear end of the hydroxyl-radical forming tank process treatment water outlet 2-5 to be connected to the gas-liquid separation tank hydroxyl-radical forming tank process treatment water inlet 3-2, the gas-liquid separation tank exhaust gas discharge port 3-6 is formed to discharge the exhaust gas such as CO₂ or N₂ after the non-biodegradable process water is decomposed, thus increasing the ozone dissolution rate when circulating and introducing the gas-liquid separation tank circulating water into the ozone dissolving tank 1-1, the gas-liquid separation tank circulating water outlet 3-5 circulated to the ozone-dissolving-tank circulating water inlet 1-2-1 is formed, thus controlling the availability of the ozone gas by adjusting to the process-water flow rate (the sum of the process-raw-water flow rate and the circulating-water flow rate) of the G/L ratio (ozone gas flow rate/liquid flow rate) which is the ratio of the ozone-gas flow rate G to the process-water flow rate L. The control panel is the electric control panel 4-1 for the gas-liquid separation tank 3-1, the motor/motor head 1-4, the DC power supply, and the pump.

The controllable advanced decomposition equipment for the industrial process-water containing the non-biodegradable organics and in-organics configured as such can efficiently achieve the advanced decomposition of the non-biodegradable process water; when the process treatment water treated through the ozone dissolving tank 1-1, the hydroxyl-radical forming tank 2-1, and the gas-liquid separation tank 3-1 in the first stage is transferred to the ozone dissolving tank 1-1 in the second stage, the process treatment water is sucked through the ozone dissolving tank process-raw-water inlet 1-2-2 of the ejector 1-2 which is formed on the front end of the ozone dissolving tank to suck the water through the negative pressure, the availability of the ozone is maximized in the ozone dissolving tank, the generated amount of the hydroxyl radicals is maximized in the hydroxyl-radical forming tank 2-1 to decompose the non-biodegradable process water, the exhaust gas is discharged from the gas-liquid separation tank 3-1, the process treatment water is highly decomposed in the ozone dissolving tank and the hydroxyl-radical forming tank in the third stage, the exhaust gas is discharged from the gas-liquid separation tank, and then the final process treatment water is discharged.

The effects of the controllable advanced decomposition equipment for the industrial process-water containing the non-biodegradable organics and in-organics according to the present disclosure are as follows.

First, an ozone dissolving tank of the present disclosure performs a rapid stirring operation at high speed when bubbles diffused in a diffusion stone 1-6 are dissolved with a motor/motor head 1-4 located at the upper end of the outer circumference and a flat-plate impeller 1-5 connected therewith and formed on the lower portion of the center of the inside, thus increasing a mass transfer rate to process raw water and allowing the upper and lower portions of the ozone gas to be smoothly mixed by an ozone dissolving tank double inner-wall fluid circulator formed on the lower portion of the inner wall of the ozone dissolving tank while maintaining a residence time, and thereby increasing the mass transfer rate of the ozone gas into the process raw water and greatly increasing an ozone dissolution rate due to horizontal agitation and an increase in vertical mixing flow.

Second, a hydroxyl-radical forming tank of the present disclosure forms positive and negative electrodes 2-3 and a semiconductor catalyst 2-4 to control the rate-determining step of an ozone decomposition reaction and thereby generate a large amount of hydroxyl radicals, and forms a hydroxyl-radical forming tank process treatment water outflow weir overflow part 2-6 to prevent channeling, thus promoting an advanced decomposition reaction by hydroxyl radicals due to uniform contact of charged semiconductor catalyst with ozone dissolution circulating water/process raw water.

Third, a gas-liquid separation tank of the present disclosure forms a gas-liquid separation tank exhaust gas discharge port 3-6 to discharge exhaust gas such as CO₂ or N₂ after non-biodegradable process water is decomposed, thus increasing an ozone dissolution rate when the gas-liquid separation tank circulating water is circulated and introduced into the ozone dissolving tank 1-1, and forms a gas-liquid separation tank circulating water outlet 3-5 circulated to an ozone-dissolving-tank circulating water inlet 1-2-1, thus controlling the availability of ozone gas by adjusting a G/L ratio, which is the ratio of an ozone-gas flow rate G to a process-water flow rate L, to the process-water flow rate (the sum of the process-raw-water flow rate and the circulating-water flow rate).

Fourth, controllable advanced decomposition equipment for industrial process-water containing non-biodegradable organics and in-organics of the present disclosure is configured in multiple stages, so that a general high-speed motor is used instead of using an expensive turbo motor in an ozone dissolving tank, thus enhancing economic efficiency, and a dead-space of the ozone dissolving tank is reduced, thus enabling smooth mixing and structurally maximizing ozone availability.

What is claimed is:

1. A controllable advanced decomposition equipment for industrial process-water containing the non-biodegradable organics and in-organics, the equipment comprising:
an ozone dissolving tank rapidly stirring ozone gas at high speed when bubbles diffused in a diffusion stone are dissolved with a motor/motor head located at an upper end of an outer circumference and a flat-plate impeller connected therewith and formed on a lower portion of a center of an inside, in order to dissolve the ozone gas, which is generated in an ozone generator and is introduced into a center of a lower portion, in process raw water which is introduced through an ozone dissolving tank process-raw-water inlet formed on an ejector, thus increasing a mass transfer rate to the process raw water and allowing upper and lower portions of the ozone gas to be smoothly mixed by an ozone dissolving tank double inner-wall fluid circulator formed on a lower portion of an inner wall of the ozone dissolving tank while maintaining a residence time, and thereby increasing the mass transfer rate of the ozone gas into the process raw water and greatly increasing an ozone dissolution rate due to horizontal agitation and an increase in vertical mixing flow;
a hydroxyl-radical forming tank located to be connected to the ozone dissolving tank ozone dissolution circulating water/process raw water outlet, wherein positive and negative electrodes and a semiconductor catalyst are formed to control a rate-determining step of an ozone decomposition reaction and thereby generate a large amount of hydroxyl radicals, and a hydroxyl-radical forming tank process treatment water outflow weir overflow part is formed to prevent channeling, thus promoting an advanced decomposition reaction by the hydroxyl radicals due to uniform contact of the charged semiconductor catalyst with the ozone dissolution circulating water/process raw water; and
a control panel located at a rear end of the hydroxyl-radical forming tank process treatment water outlet to be connected to a gas-liquid separation tank hydroxyl-radical forming tank process treatment water inlet, wherein a gas-liquid separation tank exhaust gas discharge port is formed to discharge exhaust gas such as CO₂ or N₂ after non-biodegradable process water is decomposed, thus increasing an ozone dissolution rate when circulating and introducing gas-liquid separation tank circulating water into the ozone dissolving tank, a gas-liquid separation tank circulating water outlet circulated to the ozone-dissolving-tank circulating water inlet is formed, thus controlling availability of the ozone gas by adjusting to a process-water flow rate (a sum of the process-raw-water flow rate and the circulating-water flow rate) of a G/L ratio (gas flow rate/liquid flow rate) which is a ratio of an ozone-gas flow rate to a process-water flow rate, so that the control panel is an electric control panel for a gas-liquid separation tank, the motor/motor head, a DC power supply, and a pump,
whereby, when the process treatment water treated through the ozone dissolving tank, the hydroxyl-radical forming tank, and the gas-liquid separation tank in a first stage is transferred to the ozone dissolving tank in a second stage, the process treatment water is sucked through the ozone dissolving tank process-raw-water inlet of an ejector which is formed on a front end of the ozone dissolving tank to suck the water through negative pressure, the availability of the ozone is maximized in the ozone dissolving tank, the generated amount of the hydroxyl radicals is maximized in the hydroxyl-radical forming tank to decompose the non-biodegradable process water, exhaust gas is discharged from the gas-liquid separation tank, the process treatment water is highly decomposed in the ozone dissolving tank and the hydroxyl-radical forming tank in a third stage, the exhaust gas is discharged from the gas-liquid separation tank, and then final process treatment water is discharged, so that the equipment efficiently achieves the advanced decomposition of the non-biodegradable process water.

2. A hydroxyl-radical forming tank, comprising:
a hydroxyl-radical forming tank upper flange and a hydroxyl-radical forming tank upper-flange bolt hole having a hole used to fasten the hydroxyl-radical forming tank upper flange so as to prevent fluid of the hydroxyl-radical forming tank from leaking out; and
a DC power supply and an electrical connector of hydroxyl-radical forming tank positive and negative electrodes having a connector to which an electric wire is connected to supply electricity,
wherein a semiconductor catalyst is charged by receiving electrons generated from the positive and negative electrodes supplied with the electricity, the charged catalyst controls a rate-determining step of an ozone decomposition reaction to generate a large amount of hydroxyl radicals, a hydroxyl-radical forming tank process treatment water outflow weir overflow part is formed on an inner circumference of the hydroxyl-radical forming tank process treatment water outlet to prevent channeling, and thereby promoting an advanced decomposition reaction of the non-biodegradable process water through uniform contact of the hydroxyl radical, ozone dissolution circulating water/process raw water introduced into the hydroxyl-radical forming tank circulating water/ozone dissolution process-raw-water inlet, and the charged semiconductor catalyst.
